(19) United States
(12) Patent Application Publication
(10) Pub. No.: US 2002/0093678 A1
(43) Pub. Date: Jul. 18, 2002

(54) Managing and searching digital images

(76) Inventors: John M. Skidgel, (US); Su M. Quek, (US); Crystal L. Trexel, (US); Eva Manolis, (US); Chase D. Garfinkle, (US)

Correspondence Address: Bao Tran, Tran & Associates, 3103 Glen Alto Court, San Jose, CA, 95148, US

(21) Appl. No.: 09/972,602

(22) Filed: Oct. 5, 2001

Related U.S. Application Data
(60) Provisional application No. 60/241,718, filed on Oct. 17, 2000.

(51) Int. Cl. G06F 15/00; B41J 1/00

(52) U.S. Cl. 358/1.15

(57) ABSTRACT

A system and method is provided for associating key words with each stored image. The key words can be searched along with title, backprint and other information to locate a particular image. Key words can be of different types allowing the user to easily search for stored images. Customers can assign keywords to each image including plural key words of the same type. The customer can create Boolean search strings to locate particular images. The search results can be refined if too many images match the search criterion.

### CROSS-REFERENCES TO RELATED APPLICATIONS

This application claims priority from Provisional Application Ser. No. 60/241,718, filed on Sep. 17, 2000, the content of which is hereby incorporated by reference.

### TECHNICAL FIELD

The present application relates generally to image based products and more specifically to managing manipulating digital images stored at remote server.

### BACKGROUND

Images can be generated in several ways. For example, an image can be captured using a film or digital camera and/or created and edited using image processing software such as ADOBE PHOTOSHOP® or the GNU IMAGE MANIPULATION PROGRAM (“GIMP”). Images captured using a film camera typically are stored as film negatives. Images captured using a digital camera typically are stored as digital files residing in the memory of a digital camera and/or a storage medium to which the file has been transferred (for example, a hard drive or CD ROM). Images created using image processing software are typically stored as a digital file residing on a computer readable medium such as a hard drive.

An image-based product can be generated from such stored images. As used here, the term “image-based product” refers to an item, regardless of medium, that includes a visual representation of at least a portion of one or more images. One example of an image-based product is an image print (also commonly referred to as a “photograph”). For example, a user can take a picture using a conventional film camera and then bring the exposed film to a photo-finishing laboratory to have the laboratory develop the exposed film and generate an image print

The image-based product is often a physical manifestation of the digital content. The physical manifestation of the digital content may include photographic prints of the one or more digital images, framed photographic prints, photo-album pages bearing one or more digital images, compositions of digital images and other graphical and/or textual content, and/or artifacts bearing a digital image such as a novelty item, a shirt, a coffee mug, a key-chain, a mouse pad, a magnet, or a deck of playing cards.

When a customer wishes to have a high-quality image print generated from a digital image, the customer need not physically take the digital image to a photo-finishing laboratory and instead can electronically transmit the digital image to an “online” photo-finishing laboratory using a computer network such as the Internet For example, the customer can use an Internet browser program (referred to herein as a “browser”) such as NETSCAPE NAVIGATOR®. The customer can direct the browser to a web site associated with the online photo-finishing laboratory and upload the digital image to a server hosting the web site. The online photo-finishing laboratory can then take the digital image from the web server and produce a high-quality image print from the digital image in a conventional manner. The online photo-finishing laboratory then typically sends the high-quality image print to the customer using a delivery service such as the UNITED STATES POSTAL SERVICE or FEDERAL EXPRESS®.

### SUMMARY

Aspects of the invention can include one or more of the following advantages. The present invention provides an easy method to locate images stored on a remote server. A system is provided for associating key words with each stored image. The key words can be searched along with title, backprint and other information to locate a particular image. Key words can be of different types allowing the user to easily search for stored images. Customers can assign keywords to each image including plural key words of the same type. The customer can create Boolean search strings to locate particular images The search results can be refined if too many images match the search criterion.

The details of one or more embodiments are set forth in the accompanying drawings and in the description below. Other features, objects, and advantages of the invention will become apparent from the description and drawings, and from the claims.

### DRAWING DESCRIPTIONS

FIG. 1 is a block diagram of a system for generating image-based products from digital images.

FIG. 2 is block diagram of the user image database.

FIG. 3 shows the digital image data area the user image database of FIG. 2

FIG. 4a is a flow diagram of a high-level process for offering image-based products for sale over a computer network.

FIGS. 4b1-3 show user interfaces for viewing images that have been added to the user image database or an album stored therein.

FIG. 4c shows a user interface for editing picture details.

FIG. 4d shows one example of a user interface 500 that can be used to select an image for subsequent processing.

FIGS. 4e1 and 4e2 show a user interface presented by a search engine.

FIG. 4f shows a user interface that includes search results returned by the search engine.

FIG. 4g shows a user interface presented by the search engine for refining a search.

FIGS. 4h-k show user interfaces where selected images are maintained while the user navigates through various functional areas supported by the on-line photofinishing provider (i.e., the server 35).

FIG. 5 shows a user interface presented when uploading a series of images to the on-line photofinishing provider (i.e., the server 35).

Like reference numbers and designations in the various drawings indicate like elements.

### DETAILED DESCRIPTION

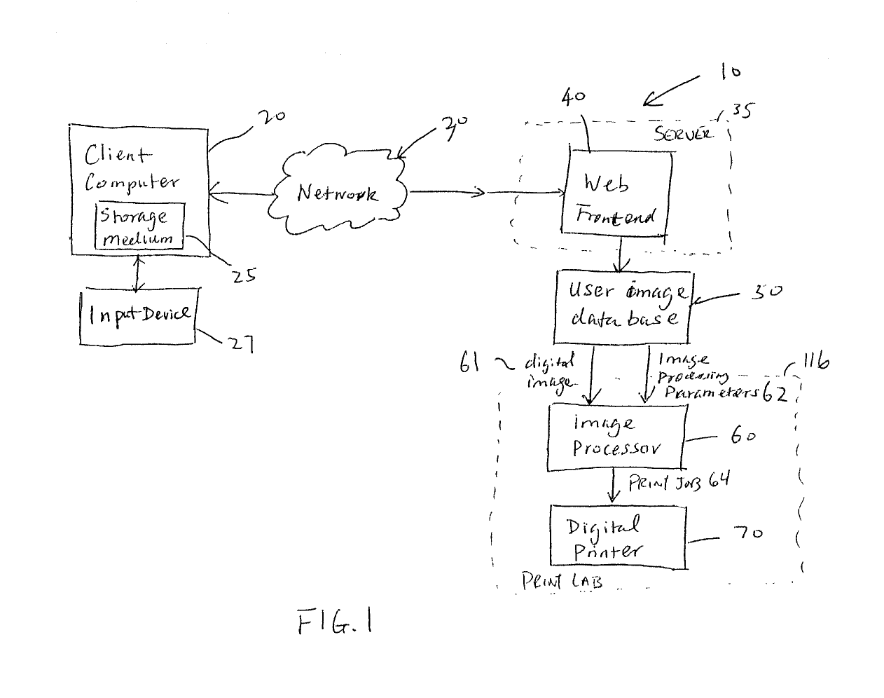

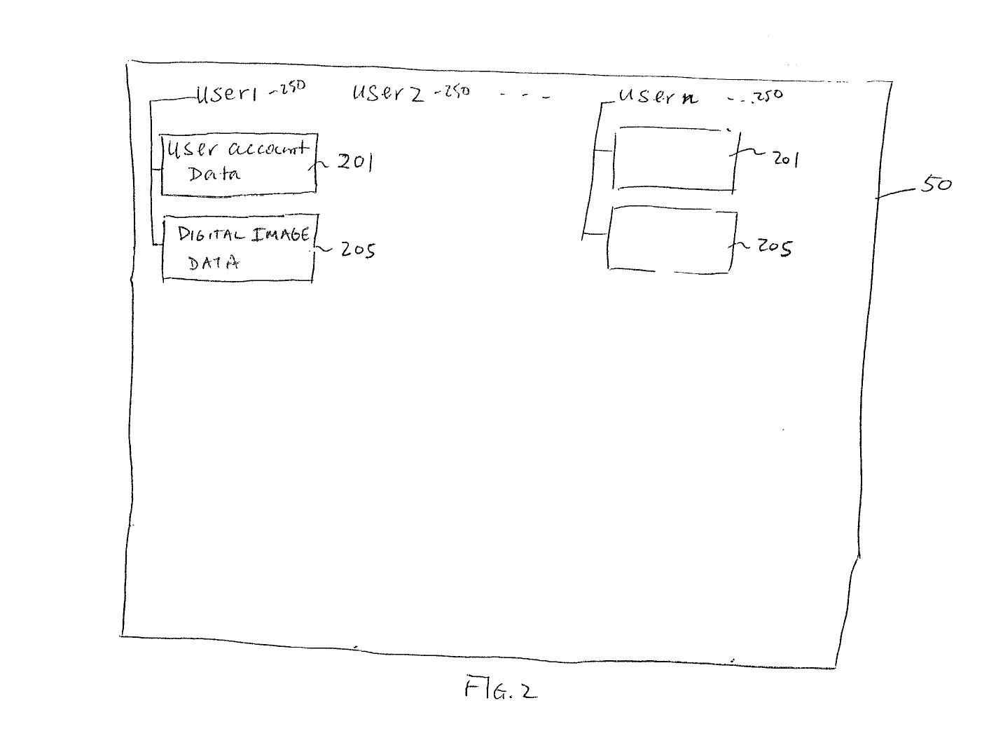

FIG. 1 is a block diagram of a system 10 for generating image-based products from digital images. System 10 includes a server 35 that is connected to one or more client computers 20 by a network 30 such as the Internet The client computers 20 can be connected to an input device 27 so that a user can upload captured digital images from an input device 27 to the client computer 20. The input device can be a digital camera, a scanner for scanning reflective printed images, or a film scanner.

Alternatively, or in addition, the client computer 20 can execute image processing software such as ADOBE PHOTOSHOP® or the GIMP in order to create and/or edit digital images. The client computer 20 includes a storage medium 25 such as a hard disk for storing the digital images. The client computer 20 can be implemented using a variety of hardware and software. For example, the client computer 20 can be a general-purpose device such as a personal computer, portable computer, or portable digital assistant (“PDA”) or as a special-purpose device such as a point-of-sale kiosk having an embedded computer.

The client computer 20 is connected to the network 30, for example, using a modem or network interface card. The system 10 can be implemented as a browser-based system in accordance with the standard protocols for communicating over the Word Wide Web. In such an implementation, a user of the client computer 20 can execute a browser to connect to and interact with the server 35. The server 35 includes a web front end 40 that manages the communications with the client computer 20. The user of the client computer 20 can upload digital images to the server 35 The web front end 40 receives the uploaded digital images and stores them in a user image database 50.

The user of the client computer 20 can also order image prints made from selected images. The server 35 includes, or is connected to, a print lab 116. The print lab 116 includes an image processor 60 and one or more digital printers 70. The image processor receives selected images 61 from the user image database 50 along with image processing parameters 62. The image processing parameters 62 can include customer specific preference data. Image processor 60 includes one or more engines for operating on the selected images 61 in accordance with the image processing parameters 62 specified for the customer. An appropriate digital printer 70 is provided with a print job 64 that can be used to generate image prints from the selected images in accordance with the preference data. The print lab 116 can generate other image-based products. For example, the print lab 116 can frame image prints in one or more frames selected by the user and/or print or otherwise embody the selected images in other items such as clothing, buttons, mugs, cards, invitations, and calendars. The items generated by the print lab 116 can be shipped to the user using a conventional shipping service such as the UNITED STATES POSTAL SERVICE or FEDERAL EXPRESS®. Commonly assigned co-pending U.S. patent applications Ser. Nos. 09/428,871 (entitled “MULTI-TIERED IMAGE DATABASE” and filed Oct. 27, 1999), Ser. No. 09/436,704 (entitled “DISTRIBUTING IMAGES TO MULTIPLE RECIPIENTS” and filed Nov. 9, 1999), and Ser. No. 09/450,075 (entitled “PRINTING IMAGES IN AN OPTIMIZED MANNER” and filed Nov. 29, 1999), all of which are incorporated herein by reference, disclose various approaches to implementing a system 10 for generating image-based products from digital images.

FIG. 2 is block diagram of the user image database 50 of FIG. 1. The user image database 50 can include a plurality of user account data structures 250 including account information for a user (e.g., user 1, user 2, . . . user n). Each user account data structure includes information specific to that particular user. In one implementation, each user account data structure 250 includes user account data 201 and digital image data 205. Other data can be stored in that account data structure including preferences, sharing information, use data and order information. For the purposes of this application, attention will be directed to the information stored with a respective image.

User account data 201 includes general information concerning the user (e g., name, address, shipping options, payment options) and may include other user identifying data such as age, profession, region, and ethnic or culture interests.

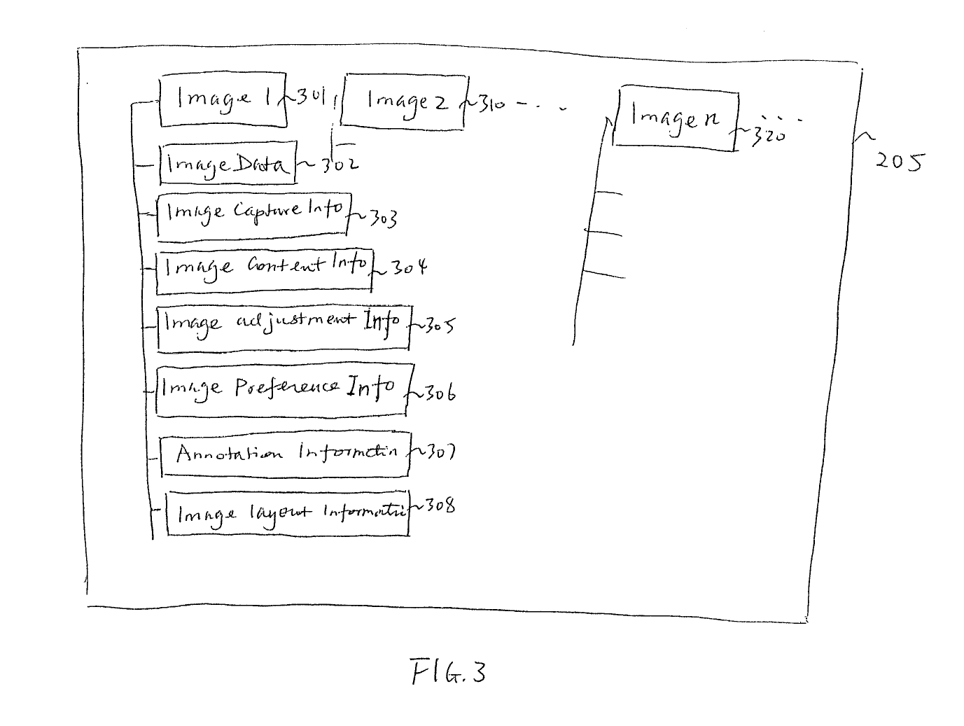

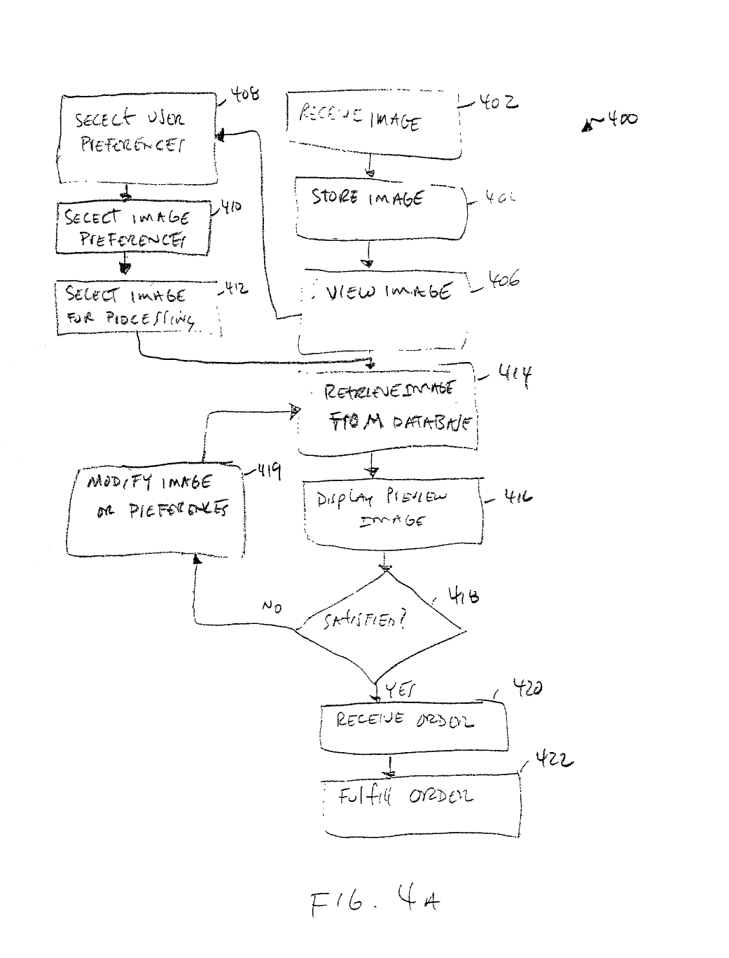

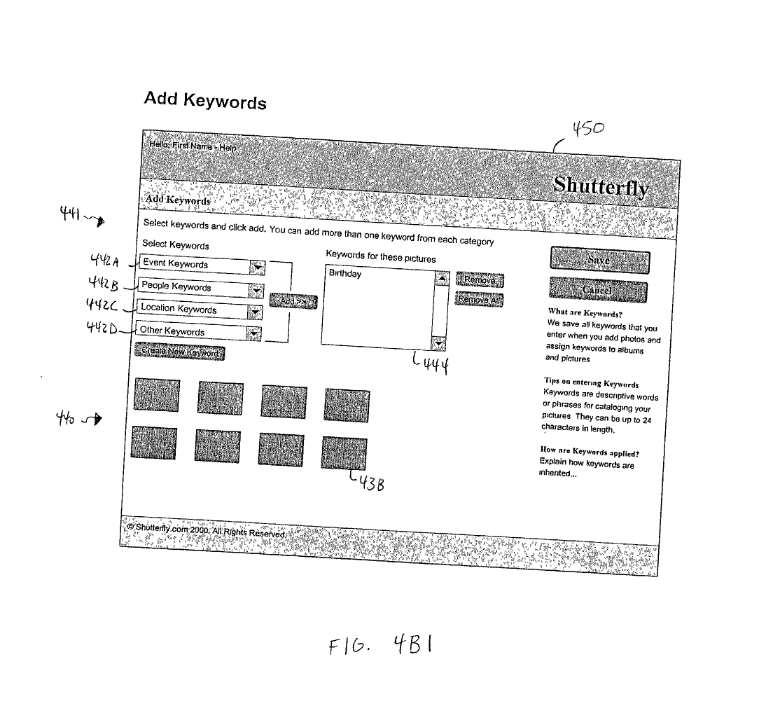

Image data is stored in digital image data area 205. The digital image data area 205 can include image data, preferences, capture, adjustment and other information that is specific to a particular image. Referring now to FIG. 3, digital image data area 205 includes one or more digital image data structures 301. The digital image data structure 301 includes image data 302, image capture information 303, image content information 304, image adjustment information 305, image preference information 306, annotation information 307 and image layout information 308.

Image data 302 includes the digital image that has been uploaded or otherwise received for processing. The image data can be in a compressed or uncompressed form. The image data includes a title, file name, an album reference (if any), date (taken), source identifier, resolution information and file size.

Image capture information 303 includes specific information relating to the source that captured the image data and can include camera type, capture speed and illumination condition such as day light, fluorescent, Tungsten, or flash light exposure Image adjustment information 305 includes definitions for image processing operations that are to be applied to the image such as color and tonal adjustment, sharpening, cropping and the like. These adjustments can be defined by image processing software resident on the customer's client computer such as Adobe Photoshop, or image processing software that is accessed locally or remotely in association with an online photofinishing provider such as Shutterfly, Inc., reachable on the web at Shutterfly.com. In the prior case, the image quality of the printed image can be simulated by displaying each processed image on a display at the user's client computer prior to connecting to the online photofinishing provider. The history of the image adjustments can be automatically recorded and sent together with image data to the online photofinishing provider and stored in image adjustment information 305. In simulating the printed image, the user's display is preferably calibrated.

Image preference information 306 can include preferences specific to the image content. In certain images, the user may prefer to adjust the color and tone to optimize the main subjects in the image.

Annotations or other textual or graphical additions to be applied to any surface of the image-based product can be stored in the annotation information 307. For example, annotations can be applied to the back of an image print in a process referred to as backprinting (backprinting message). Backprinting is described in greater detail in copending U.S. patent application entitled “Backprinting Image Prints”, filed Nov. 29, 1999 and assigned Ser. No. 09/450,899, the contents of which are expressly incorporated herein by reference.

Key words can be assigned to each image print Key words are descriptive words or phrases for cataloging images or albums. The key words can be used to easily locate images from storage. Key words can be of different types. In one implementation, key words are defined to be of four types including: event, people, location and other. Event key words are used to describe the event that the image memorializes or relates to. People key words can be used to identify the subjects in an image. People key words can be used to identify people as well as animals or other named subjects Location key words can be used to identify the location or setting for an image. The other category can be used to create key words that do not fall into one of the other categories. In one implementation, plural keywords of each type can be associated with a single image.

Layout and other output information can be stored in image layout information 308. For example, the user can specify one or more mattes, frames or border effects to be applied to a periphery of a selected image. The specification of layout designs is described in greater detail in co-pending application entitled “System and Method of Changing Attributes of an Image-based Product”, filed Apr. 28, 2000 and assigned serial number (unknown), the contents of which are expressly incorporated herein by reference.

Image Offering and Manipulation

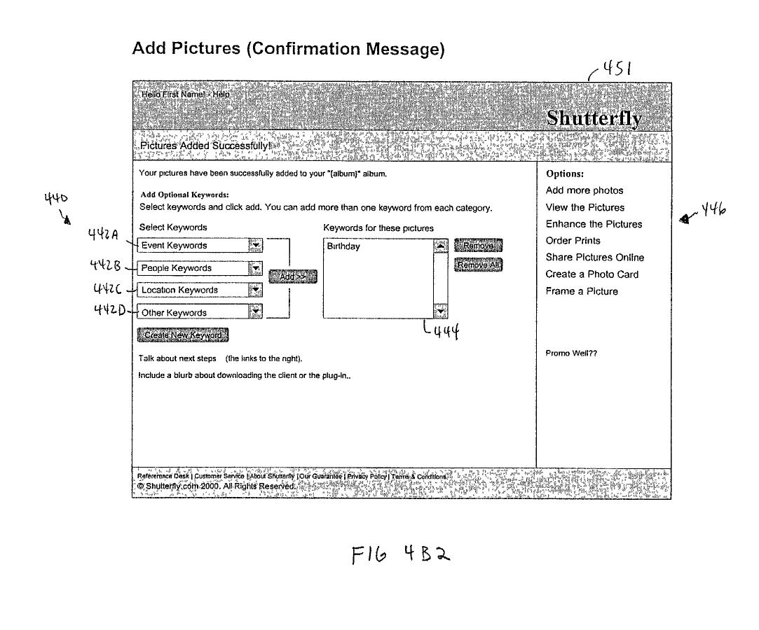

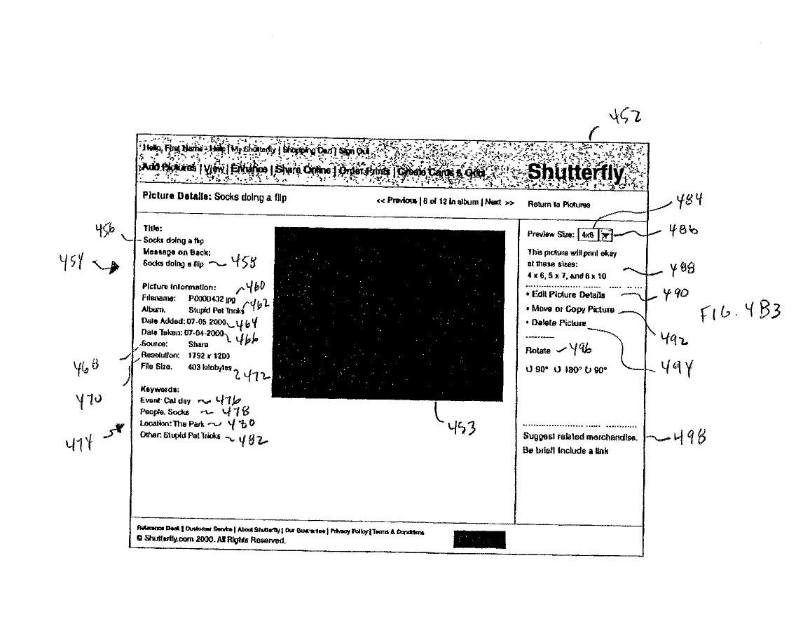

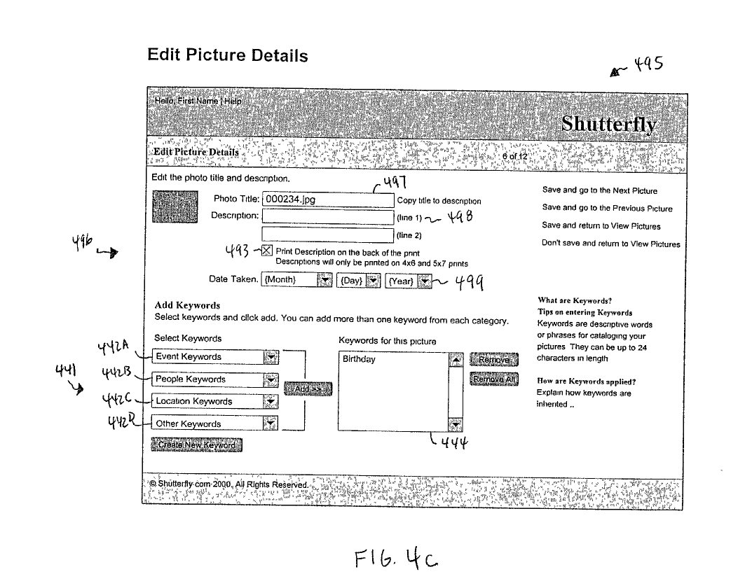

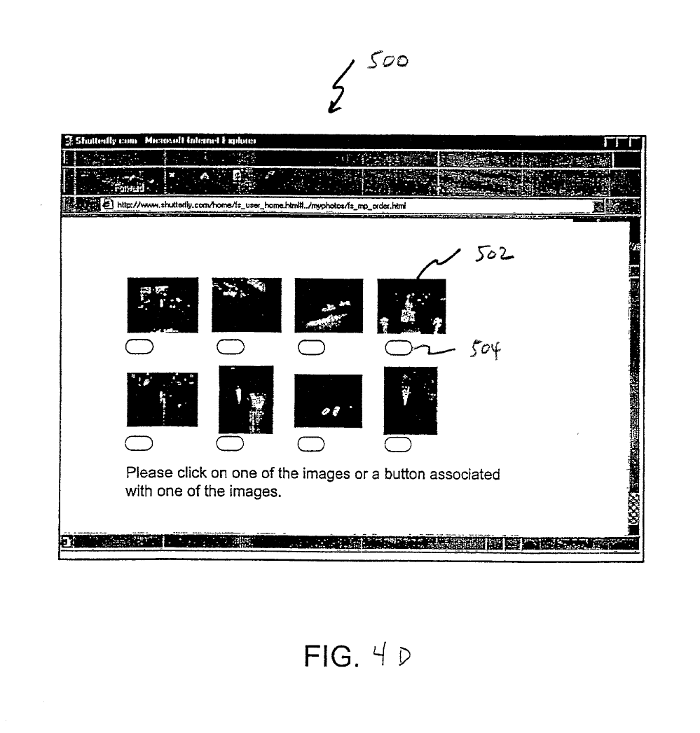

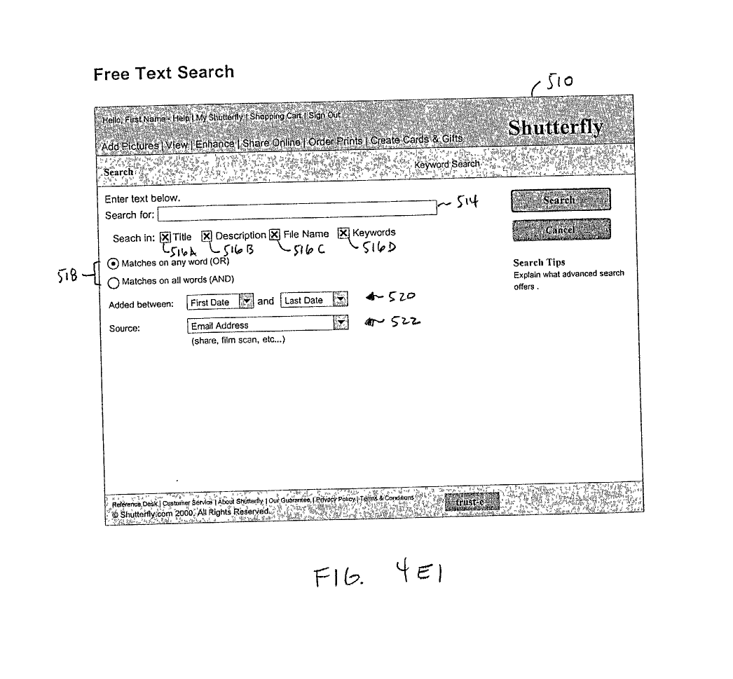

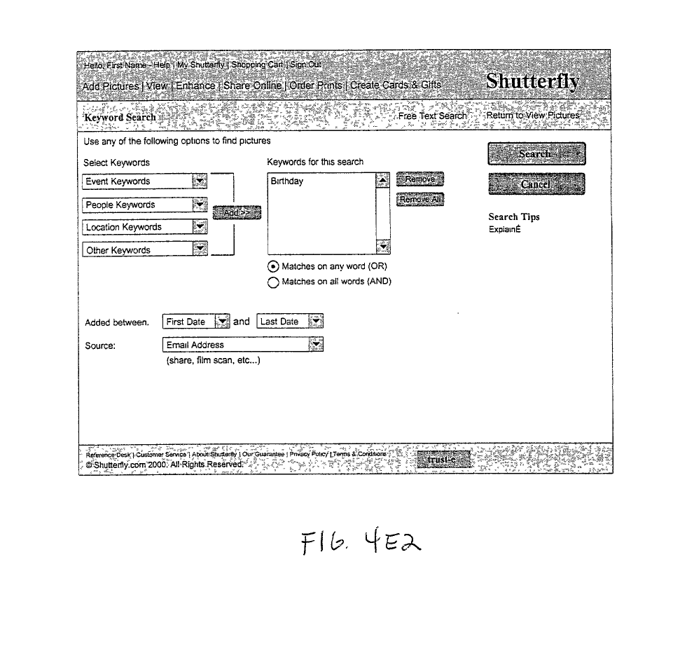

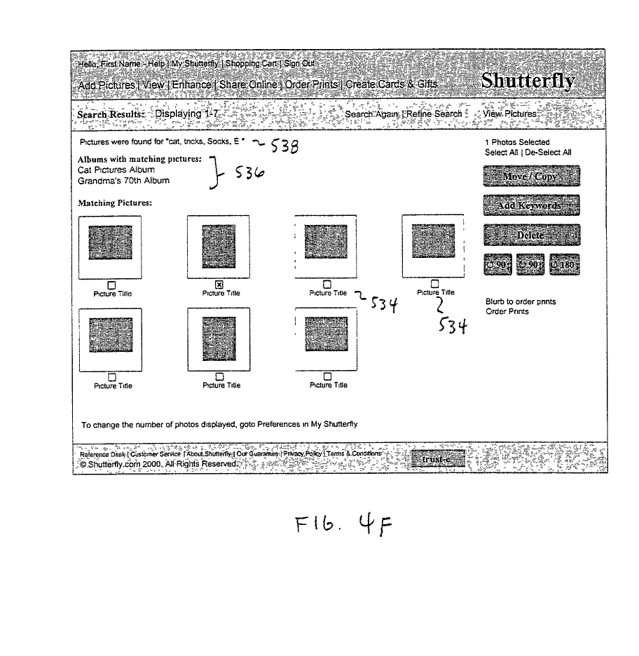

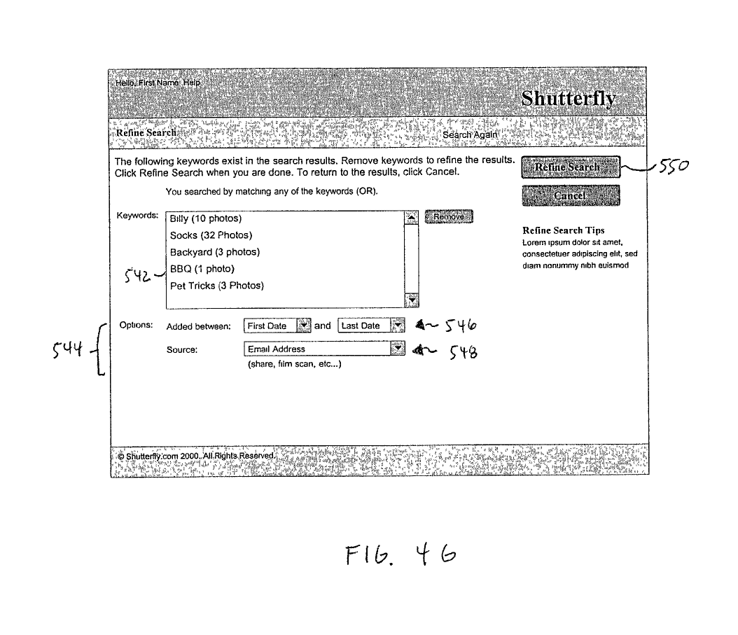

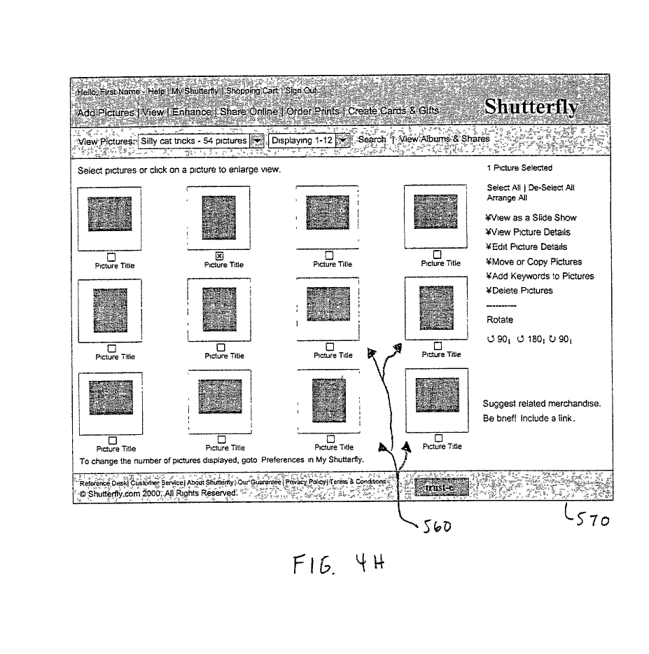

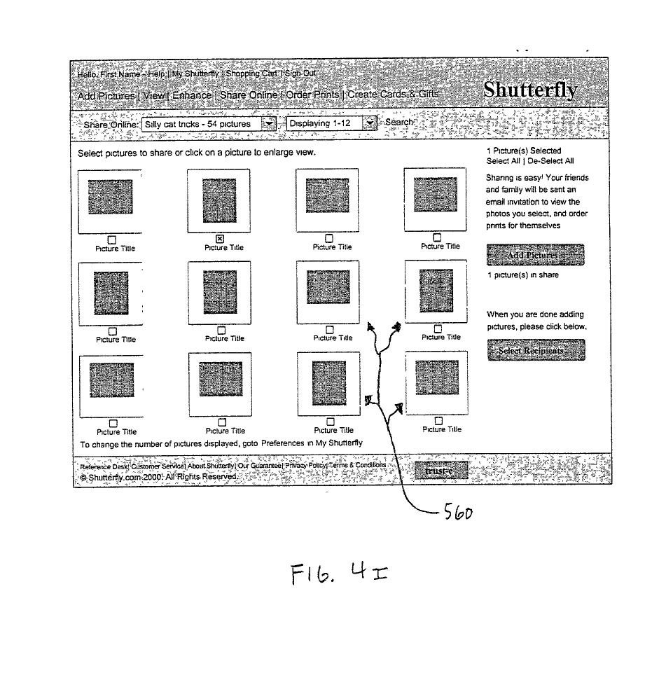

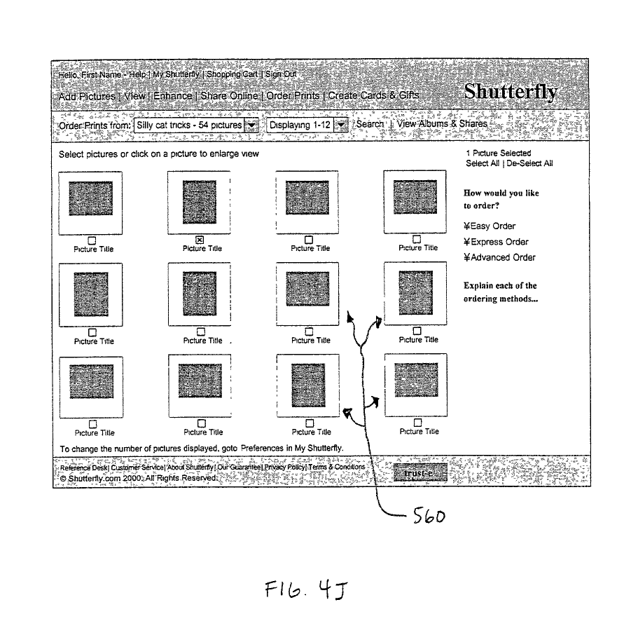

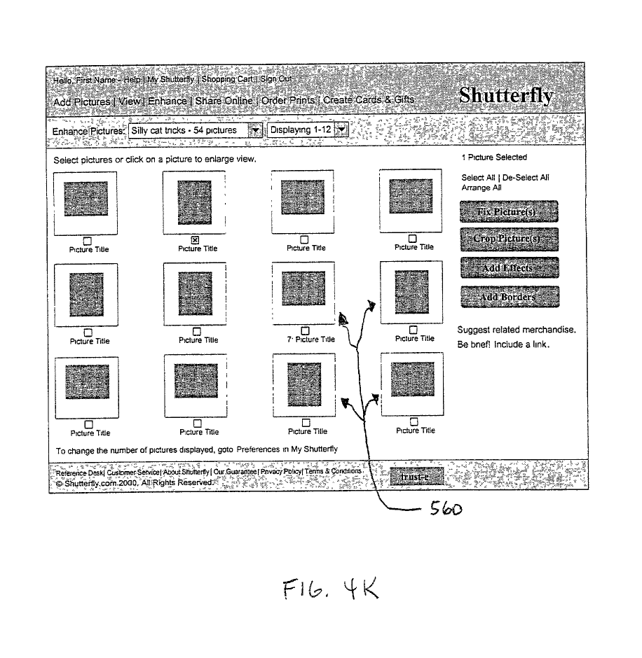

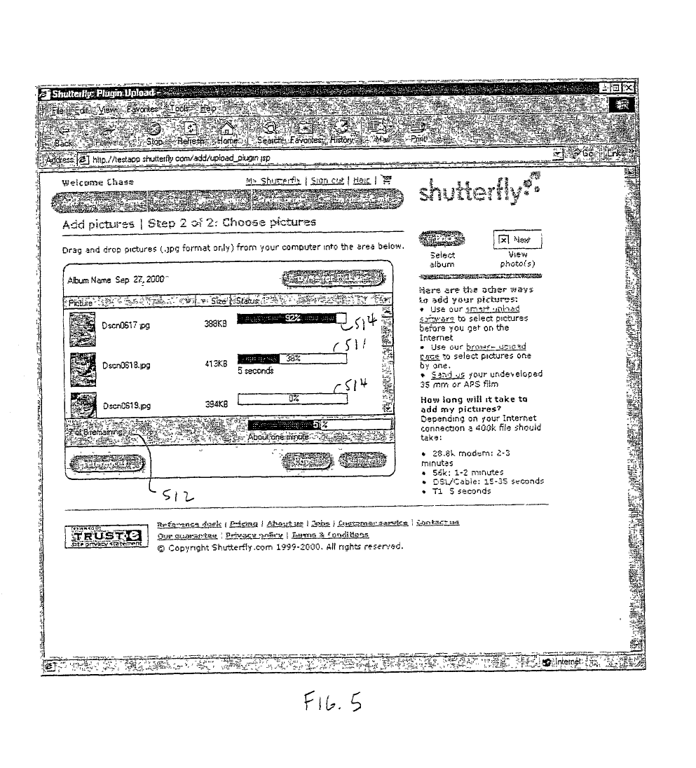

FIG. 4a is a flow diagram of a high-level process 400 for offering image-based products for sale over a computer network such as the Internet (e g, using system 10 shown in FIG. 1). First, an image is received (block 402) For example, a user executing a browser on the client computer 20 can access the web front end 40 of the server 35 and upload a digital image to the server 35. An example of a user interface displayed when uploading a digital image to the server is shown in FIG. 5. The user interface includes status bars for indicating both the overall upload status 512 for a given transfer and the upload status for each individual image 514. The server 35 receives the uploaded image, which the user can select for subsequent processing as described below. The uploaded digital image can be stored in the user image database 50 (404). As described above, the user image database includes placeholders for image data associated with a given digital image as well as other related data structures (preferences, annotations and the like). The web front end 40 can be configured to allow the user to view images stored in the user image database 50 on the server computer (406), select user preferences (408) and image preferences (410) and select one or more images for subsequent processing (412). Subsequent processing can include the ordering and sharing of image-based products and the creation of albums.

Viewing Images and Key Words

FIG. 4b1 shows one example of a user interface 450 that can be used to allow a user to view uploaded or other wise received digital images. After an image has been successfully transferred to the server, a confirmation message can be sent to the user through the web front end. For example, user interface 450 can be presented to the user to allow for the capturing of additional information to be associated with the digital image that is to be stored in the user image database 450. The user interface 450 can include an image display area 440 including one or more images 438 and key word frame 441. The images 438 can be thumbnail versions of uploaded images. An image can be selected from the group of uploaded images in the display area 440 and assigned key words using key word frame 441. The key word frame 441 can include plural selectors 442 and a message area 444. Each selector can be associated with a particular type of key word. In the example shown, four selectors 442a-d are included, one for each key word type (e.g., event, people, location and other). By selecting a desired selector 442, a list of all current key words of the selected type is presented in the message area 444. The user can edit any of the key words in the message area 444, add new words or delete words as desired.

A similar user interface 451, shown in FIG. 4b2, can be used to assign key words to digital images as they are added to an album. An album is a named grouping of digital images. Albums can be shared among users. When viewing images in an album, the user can scroll through the various images, edit, add, delete and place orders for individual images or the entire album. When images are added to an album, a user interface as shown in FIG. 4b2 is used to allow a user to add or modify the key words associated with a given image. The album addition user interface 451 includes options links 446 (e.g., add more photos link, view pictures link and order prints link) that can be used to select a next functional context to be exploited by the user.

FIG. 4b3 shows another example of a user interface 452 that can be used to allow a user to view uploaded digital images. The user interface 452 is used in conjunction with an album and can be used to allow a user to view an individual picture from the album. When an album is selected for processing by a user, each image in the album can be viewed. A user interface 452 presented for an image in an album includes a preview window 453 for presenting an image stored in the user image database 50. In addition, the user interface 452 includes picture details 454 including a title 456, backprinting message 458, file name 460, associated album name (if any) 462, date added (to the album) 464, date taken 466, source 468, resolution 470 and file size 472. The data used to fill the picture details 454 is stored in user image database 50. In addition, the user interface can include a key word listing 474 that includes key words for each category (if any) including event key words 476, people key words 478, location key words 480 and other key words 482.

The user interface 452 can include a preview size indicator 484 that indicates the current selected preview size associated with a given image. The preview size data is used in generating the preview image 453. Associated with the preview size indicator 484 can be a toggle switch 486 for allowing the user to select among the available printable sizes of the selected image. The available size data 488 is calculated based on the resolution of the digital image. Once selected, the appropriate sized digital image can be displayed in the preview window 453.

The user interface can include one or more buttons or links that can be used to manipulate the selected digital image. In the implementation shown, three links are included in the user interface including an edit picture detail link 490, a move or copy link 492 and a delete picture link 494. Individual images can be edited by selecting the edit picture detail link 490.

The edit picture detail link, when selected, results in the display of a user interface 495 as shown in FIG. 4c. User interface 495 includes a key word frame 441 and a detail frame 496. The key word frame 441 is identical to that described above and includes plural selectors 442 and a message area 444. Detail frame 496 includes fields for entering data to be associated with a given image in an album. Detail frame 496 includes a title field 497 for entering the title of the image, a description field 498 for entering an annotation to be printed on a surface of the image, an annotation location selector (e.g., backprinting selector 493) for indicating an annotation location selection, and a date field 499 for entering a date that the image was taken.

Continuing in the process for offering an image-based product, an image can be selected for subsequent processing (block 412). FIG. 4d shows one example of a user interface 500 that can be used to select an image for subsequent processing. User interface 500 includes a plurality of “thumbnail” versions 502 of images stored in the user image database 50 (also referred to here as “thumbnails”). User interface 500 can be configured in a conventional manner so that a user can select a particular image by clicking on the thumbnail 502 associated with that image or a button (504) associated with one of the images.

Alternatively, the user can select an image using a search engine. The search engine can include tools for searching through data associated with each image in the user image database 50 to locate a desired image. The search can be simple or exhaustive including all data associated with a digital image that is stored in the user image database 50. In one implementation, the user interface 510 presented by the search engine is as shown in FIG. 4e1. The user interface 510 can include a plurality of search fields 512 including a text field 514, search location selections 516, match criteria 518, date criteria 520 and source criteria 522.

Text field 514 can be edited to include a text string to search for in the user image database 50. Search location selections 516 include plural selections for specifying where the search engine should look for the text string entered in the text field 514. In one implementation, search location selections include a title location 516a, description location 516b, a file name 516c and key words 516d. The user can use the location selections to limit the scope of a search.

Match criteria 518 can be used to augment the text string specified in text field 514. In the implementations shown, Boolean “and” and “or” operations can be specified to link the terms provided as part of the text string. Date criteria 520 can be used to narrow a search over a specified window of time. Source criteria 522 can be used to narrow a search to a particular source or origin. Sources can include email addresses as well as other identifiers for designating the source of origin for a given image. Other source options include share, scan, kiosk and film. FIG. 4e2 shows a user interface presented by a search engine that may be used to search for a digital image. In this user interface, searches can be performed using keywords.

Results from a search are returned to the user as shown in user interface 530 of FIG. 4f. In one implementation, all images that match the designated search criteria are identified and a thumbnail 532 of each image is provided in a display area of the user interface 530. In the implementation shown, an image title 534 is returned and displayed under each thumbnail 532. The search terms 538 can also be displayed in the user interface 530. In one implementation, the matching information is provided in two parts. In a first part described above, individual images are identified and displayed when a match is detected. In a second part, matching album information 536 can be displayed. The matching album information 536 is used to identify any albums that include an image that matches the search terms.

If a search returns too many “hits” (i.e., matching images or albums), then the search can be refined by the user Referring now to FIG. 4g, a user interface 540 is shown as presented by the search engine when a search is refined. User interface 540 can be presented automatically if too many search hits arise, or can be manually invoked. The refine user interface 540 includes a results window 542 and options selections 544. The results window includes a listing of all of the search results for each individual term of the search terms. Key words can be added, removed or edited using results window 540. Other search revisions can be made using options selections 544. User interface 540 includes options for changing date criteria 546 and source criteria 548. The refined search can be submitted for evaluation to the search engine by clicking on the refine search button 550.

Continuing in the process for offering an image-based product, the image can be received and selected in other ways, including for example, as an attachment to an email or embodied on a storage medium such as photograph, a flash memory card or CD-ROM. After an image is selected for subsequent processing, the selected image is then retrieved from the user image database 50 (414). Ultimately, a preview image for an image-based product incorporating the selected image and processed in accordance with both user-based and image-preferences is displayed (block 416 shown in FIG. 4a). An image-based product is an item, regardless of medium, that includes a visual representation of at least a portion of one or more images. Examples of image-based products include image prints, buttons, posters, mugs, clothing, and cards in which at least a portion of one or more images is printed or otherwise incorporated or embodied A preview image is a visual representation of an image-based product incorporating the selected image The preview image is displayed in order to give the user an idea of what an image-based product incorporating the selected image will look like. Proper textures can be applied to simulate the visual environment in two or three dimensions. If the customer is satisfied with the preview (block 418), an order can be placed. Alternatively, the user can change the image or customer preferences (419) (either user-based or image-based preferences) until a satisfactory result is produced.

In one implementation, plural images can be selected at a same time and previewed by the user Once one or more images are selected, the selected images can be preserved while the user navigates between functional areas of the server web front end (e.g., to place an order, share selected images or add the selected images to an album). In one implementation, selected images are displayed in each user interface in a frame while the user navigates between functional areas. Examples of this continuity are shown in FIGS. 4h-k, that show user interfaces 570, 572, 574 and 576 respectively, each including a set of selected images 560 as they are displayed across the four different functional areas (view pictures functional interface 570).

Turning again to the process for offering an image-based product, an order is received for an image-based product incorporating the selected image (block 420). For example, the order can be received by the web front end 40 from the customer's client computer 20. The order can be received in other ways including, for example, via electronic mail, Internet Relay Chat, the telephone, and/or the mail Typically, the order will include information specifying (or otherwise referring or pointing to) a type of image-based product, the image to incorporate into the image-based product, a quantity of the image-based product being ordered, payment information, and delivery information. After the order has been received, the order is fulfilled (block 422). For example, the order can be fulfilled by printing or otherwise generating the image-based product and delivering the product to the customer.

A number of embodiments have been described. Nevertheless, it will be understood that various modifications may be made without departing from the spirit and scope of the invention. For example, advantageous results still could be achieved if steps of the disclosed techniques were performed in a different order and/or if components in the disclosed systems were combined in a different manner and/or replaced or supplemented by other components.

What is claimed is:

1. A method for organizing digital images on a computer, comprising:
receiving the digital images over a network, and
associating at least one searchable keyword with each digital image to support a subsequent search for one or more selected digital images.

2. The method of claim 1, wherein the computer is a server, further comprising displaying the digital images at a client computer remotely coupled to the server.

3. The method of claim 1, further comprising uploading the one or more digital images from a client computer to the server over the network.

4. The method of claim 1, further comprising generating thumbnail images from the digital images.

5. The method of claim 1, wherein the searchable keyword includes an event keyword.

6. The method of claim 1, wherein the searchable keyword includes a people keyword.

7. The method of claim 1, wherein the searchable keyword includes a location keyword.

8. The method of claim 1, wherein the at least one searchable keyword includes two or more of the following: an event keyword, a people keyword, and a location keyword.

9. The method of claim 1, further comprising organizing the digital images based on the searchable keyword.

10. The method of claim 1, further comprising grouping the digital images into one or more albums based on the searchable keyword.

11. The method of claim 1, further comprising performing a Boolean search based on the at least one searchable keyword.

12. The method of claim 1, further comprising using a result from a first search in formulating a subsequent search.

13. The method of claim 1, further comprising displaying a thumbnail of each digital image matching the at least one searchable keyword.

14. The method of claim 1, further comprising displaying an image title with each digital image matching the at least one searchable keyword.

15. The method of claim 1, further comprising displaying an album containing one or more digital images matching the at least one searchable keyword.

16. The method of claim 1, further comprising associating image layout information with each digital image.

17. The method of claim 1, further comprising electronically distributing each digital image matching the at least one searchable keyword.

18. The method of claim 1, further comprising generating a preview of each digital image matching the at least one searchable keyword.

19. The method of claim 1, further comprising accepting an order for each digital image matching the at least one searchable keyword.

20. A user interface for organizing one or more digital images stored in a remote computer, comprising:
a display region adapted to render the one or more digital images, each image being associated with one or more searchable keywords; and
a search region adapted to receive one or more searchable keywords to locate one or more digital images matching the one or more searchable keywords.

21. The user interface of claim 20, wherein the one or more searchable keywords include one or more of the following: an event keyword; a people keyword; and a location keyword.

22. The user interface of claim 20, wherein the display region shows image, user-preference, capture, adjustment or image specific information.

22. The user interface of claim 20, wherein the display region renders a thumbnail of each image.

23. The user interface of claim 22, further comprising an image title displayed under each thumbnail.

24. The user interface of claim 20, further comprising a preview region adapted to show an image-based product incorporating a selected image processed in accordance with user-based and image-preferences.

25. The user interface of claim 20, further comprising a frame adapted to display selected images while a user navigates between functional areas.

26. A system, comprising
a network;
a server adapted to receive one or more digital images over the network, the server receiving and associating at least one searchable keyword with each digital image to allow a subsequent search for the digital image; and
a client computer adapted to upload the one or more digital images to the server over the network, the client computer allowing a user to search and view one or more selected digital images based on the at least one searchable keyword.

27. The system of claim 26, wherein the server generates thumbnail images from the digital images.

28. The system of claim 26, wherein the at least one searchable keyword includes one or more of the following: an event keyword, a people keyword, and a location keyword.

29. The system of claim 26, wherein the server electronically distributes each digital image matching the at least one searchable keyword.

30. The system of claim 26, wherein the server generates a preview page adapted to show an image-based product incorporating a selected image processed in accordance with user-based and image-preferences.
